(19) United States
(12) Patent Application Publication
(10) Pub. No.: US 2007/0182990 A1
(43) Pub. Date: Aug. 9, 2007

(54) Reproduction of documents into requested forms

(75) Inventors: Christopher Colin Stephen, Paddington (AU); Gregory Lyle Duncan, Fraser (AU)

Correspondence Address: FITCH EVEN TABIN AND FLANNERY, 120 SOUTH LA SALLE STREET, SUITE 1600, CHICAGO, IL, 60603-3406, US

(73) Assignee: Objective Systems Pty Limited, Paddington (AU)

(21) Appl. No.: 11/629,390

(22) PCT Filed: Jun. 10, 2005
(86) PCT No.: PCT/AU05/00832

§ 371 Date: Dec. 13, 2006

(30) Foreign Application Priority Data
Jun. 17, 2004 (AU) 2004903307

(51) Int. Cl. G06F 3/12; G06F 17/00

(52) U.S. Cl. 358/1.15; 715/523; 715/513

(57) ABSTRACT

The reproduction of a requested source document in a requested available form (including electronic, print, audio and Braille) is disclosed. At a server, for each one of a plurality of documents at least one access pathway is applied to a marked-up form of the document. The access pathways define discrete parts of the document. A fragment of the marked-up document is generated for each said access pathway for each available form. A requested one or more parts of a source document is generated in a requested form from the respective stored fragments. The fragments are transmitted to the requesting customer for local reproduction.

### FIELD OF THE INVENTION

The invention relates to the reproduction of documents into a requested form. The forms can include print, audio, Braille or an electronic file. It also relates to the distribution of such documents over electronic networks, and remote reproduction. The documents can be either large or small in size.

### BACKGROUND

Print Form Documents

Currently many documents are transmitted in paper, usually via post. One particularly common form of document is invoices. It is expensive for companies to print and post invoices. When they are received, they must be opened, be paid, sorted, and often information from the invoice must be data entered into a computer. This is expensive for customers. Often customers can not read the invoice they are sent because they are blind, the type is too small, the reader has a disability, or it is written in a language they cannot read. This problem extends to several other kinds of document, including bank statements, credit card statements, legal documents and letters.

Commercial computer networks, such as the Internet, have been used as a means of facilitating ordering of books and other reading material by consumers. This is typically achieved by presenting a web site-based user interface to consumers to allow them to order reading material such as books. One example of this is the website Amazon.com. However, the reading material that can be purchased by users of these systems are the same as the offering made by a traditional book store. That is, each item of reading material is usually offered in only one format. Further, users must wait whilst the reading material they ordered is retrieved from a warehouse and shipped to them.

Electronic Form Documents

The distribution of electronic documents is generally known, and is described, for example, in International Publication No. WO 00/72235 A1 (Silverbrook Research Pty Ltd, 30 Nov. 2000). Silverbrook describes text being formatted in the Extendable Mark-up Language (XML) using the Extensible Stylesheet Language (XSL).

Audio Form Documents

Digital talking Books (DTBs) are one type of audio form documents. DTBs known to the extent that there are technical standards that apply. One such standard is ANSI/NISO Z39.86-2002 “Specifications for the Digital Talking Book”, published in 2002 by the US National Information Standards Organisation, Bethesda, Md. 20814 (ISBN: 1-880124-52-1). The Z39.86 Standard deals with many aspects of DTBs, including the DTB package file, content format for text, audio file formats, image file formats, synchronisation of media files, navigation control files, portable bookmarks and highlights, resource file, packaging files for distribution and presentation files.

The Z39-86 Standard owes much to the work done by the DAISY Consortium. The DAISY 2.0 specification is based on HTML, and version 2.01, published in February 2001 (www.daisy.org/publication/specifications/daisy_{_{—}}202.html) extends the data representation to the XML DTB DTD. The DAISY format is based on the W3C-defined SGML (150 8879) applications XHTML 1.0 and SMIL 1.0. Using this framework, a talking book format is achieved that allows navigation of a marked-up text with audio. Although DAISY DTBs offer fine granularity and sophisticated navigation tools for user, their implementation requires very high computational power.

Braille Form Documents

Braille characters are made up of up to six raised impressions in two columns of three impressions. Braille characters are approximately 28 point and are always the same size and the horizontal space between characters is constant. Letters are mapped to the Braille codes and this form of Braille is called Grade 1 Braille. Grade 2 Braille has contractions applied to words to make the size of Braille documents smaller and quicker to read. In English there are different contraction rules in the US, UK, Australia, and there is now a new standard, Universal English Braille Code, which is a fourth set of rules. Many of the rules are the same. In say German, the mapping of letters to Braille codes and the contractions may be so different that a German Braille reader who can speak both English and German may not be able to read English Braille. Images in documents need to be described in words, generally using additional information to be added. In addition, some graphical information can be provided by Brailled images. A map of Australia can be Brailled, so that the outline of Australia can be shown as a series of raised dots on paper, so that a blind person can feel it.

A needs exists, however, for the reproduction, and electronic distribution of a wide variety of documents in a chosen one of a number of available forms.

### SUMMARY

The invention generally provides computer programs, methods and computer apparatus/systems for reproducing a requested source document in a requested one of available forms. Additionally, requested documents can be provided in requested formats, and be navigable.

For each one of a plurality of documents: at least one access pathway is applied to a marked-up form of the document, the access pathways define discrete parts of the document. A fragment of the marked-up document is generated for each said access pathway for each available form.

A requested one or more parts of a source document can be generated in a requested form from the respective stored fragments.

Preferably, the access pathways are defined in a configuration file. A document is assigned to a respective class, and there is a configuration file for each class. The source documents are marked-up according to a schema, and there is a separate schema for each class. The configuration file for each class may contain certain variations for each form.

The schema describes the document fully. The configuration file indicates which pieces of the full document are significant.

Advantageously, an index list is created for each request maker, the index list including a set of documents available to each request maker, and lists the access pathways for each fragment of each document. One fragment comprises the entire source document.

### DESCRIPTION OF THE DRAWINGS

FIG. 1 shows an exemplary system for generating a chosen form of document.

FIG. 2 shows another exemplary system for generating a chosen form of document.

FIG. 3 is a schematic block diagram of document server processes.

FIG. 4 shows the build process in greater detail.

FIG. 5 is a schematic block diagram of client/reproduction (user) server processes.

FIG. 6 shows an XML schema for a ‘bank statement’ class file.

FIG. 7 shows an XML schema for index document and access paths.

FIG. 8 shows an XML schema for validating index documents.

FIG. 9 is a schematic block diagram of a formatting process.

FIG. 10 shows an XML document.

FIG. 11 shows an XSL style sheet.

FIG. 12 shows an XSL:FO file.

FIG. 13 shows a bar chart for which a Braille representation is required.

### DETAILED DESCRIPTION

Definitions

Document—is intended to mean any information contained in hard copy or electronic form, and includes books, pamphlets, brochures, reports, bank statements and other written material, or voice or Braille.
Form—means the medium or file type in which information is to be reproduced, such as print, audio, Braille, electronic and visual forms.
Format—is used to describe the general presentation of written material. For print and Braille this could include such things as typeface, type size and margins, and for audio could include tone, speech and gender.
Classes of document—a grouping of documents of similar type. Document classes can include bank statements, technical or academic articles or books, legal contracts, legislation, etc. Statements issued by different banks may have small variations, but if these variations cannot be accommodated in the same schema, then they fall into another class. There is only one schema for each class.
Fragment—a fragment is the entire document, or a section of a document that relates to one of the access paths defined for that class of document. A fragment is usually rendered in the form(s) and/or format(s) requested by he customer.
Access paths/pathways—the manner in which a document may be accessed and provides the link between class documents and index documents. Access paths are also used to trigger the building and storing of output fragments. All document classes must have at least one access path, being the ‘document level’ access path (ie. the entire document).
Process configuration files—allow a single piece of software to perform a specific part of the process regardless of the document class being processed. They are specific to a document class, and perform a mapping of known actions based on specific elements within the source documents and are loaded at runtime for a process. Configuration files define access pathways and thus how fragments are to be built.
Index list—a marked-up document to a known standard (eg. XML) that defines a customer's catalogue of available documents, and defines the ways that these documents may be accessed, ie. either as whole documents and/or fragments. Index lists utilise access pathways.
   A. Overview

Source documents are the subject of a mark-up process according to an appropriate one of a number of schemas. Each such marked-up document is the subject of a build process, in which a document is analysed (according to a schema/set of rules) to determine pieces important as access paths. The access paths are defined for each document. So, for any one document the access paths are then used to create the set of fragments for that document. The fragments enable navigation of the document. The fragments are then each rendered into each one of the forms in which the document is to be available to the customer or customers entitled to see the document (for example, the person to whom the bank statement is addressed). Thus, for any one document, a set of fragments exists for each of the chosen forms that are available.

The source document can be translated as a preliminary step to the build process, to be available to customer or customers entitled to see the document (e.g. the person to whom a bank statement is addressed) in other languages. Document formatting choices can also be provided.

A customer request includes the identity of a document to be reproduced, the required form of the document, and optionally desired formatting information. An output file is produced, and is then subject to a reproduction process that utilises the access paths. The resultant forms supported in the embodiment described are a Braille physical document, a printed document, audio (eg. spoken word or music) or a physical storage medium (eg. CDROM or magnetic disk).

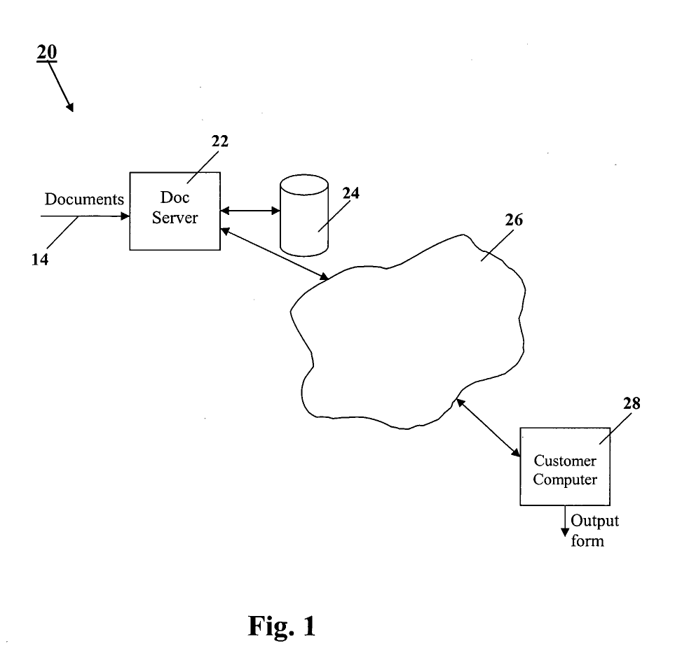

FIG. 1 shows an example of a system 20 for reproducing a chosen form of document where distribution across a network is involved. Documents 14 are input to a document server 22. The document server 22 and repository 24 can be a part of or separate to the system generating the documents 14. The document server 22 has a repository 24 in which products of the build process are stored. The document server 22 has connection with a public or private network 26. A customer computer 28 also has communication with the network 26. The customer computer 28 issues a request to the document server 22 for a specified document in a specified form, via the network 26. The document server 22 retrieves the relevant fragments from the repository 24, and then passes the fragments via the network 46 to the customer computer 28. The reproduction processes are performed at the customer computer 28.

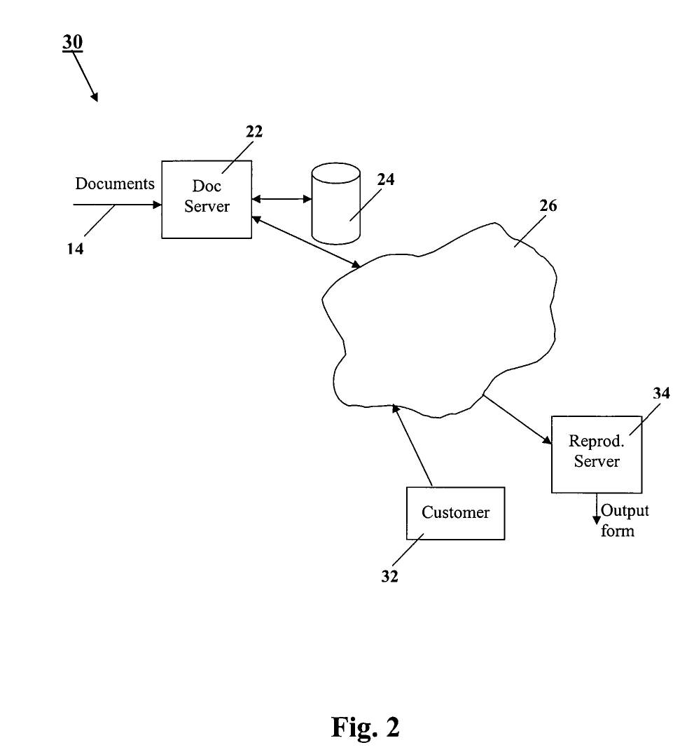

FIG. 2 shows a further system 30, that is similar to system 20 of FIG. 1 in so far as the document server 22 performs the same function in receiving requests for documents and distributing them via the network 26. The difference, however, is that whilst the request for a specific document initiates with a customer 32, the reproduction is performed by a separate reproduction client server 34, connected with the network 26. The output form of the document is separately provided to the customer, in a printed or electronic form. A benefit of the arrangement of this system 30 is that the customer need not buy and configure expensive software and an expensive (fast) computer. In typical arrangements, a reproduction server 34 (eg. a large publisher) would be located in a general geographical proximity to customers 32 (eg. in the same city or state). The document server 22, in fact, may reside in another country to the customers and the reproduction server 34. This arrangement gives efficiencies in terms of the cost of postage and the time it takes for a requested document to be provided to a customer.

Generally, it is desirable to use customer's existing computer systems, since it allows interfacing with existing financial records and systems (invoices are one form of document that can be requested), and, in the main, is the least troublesome for the customer. Customers who are visually impaired may prefer to use their existing computers and software, rather than install new software and learn how to use it. For example, presenting invoices in a DAISY format may be more convenient for someone used to a particular DAISY reader than requiring the customer to acquire and learn new software.

Some document providers, such as banks, may not easily be able to generate invoices, statements and the like in XML form. In such a situation, a bank would require specific additional software to create and format such documents then forward them to a central repository where the documents can be organised for the user and from which a user can obtain requested documents.

B. Build Process

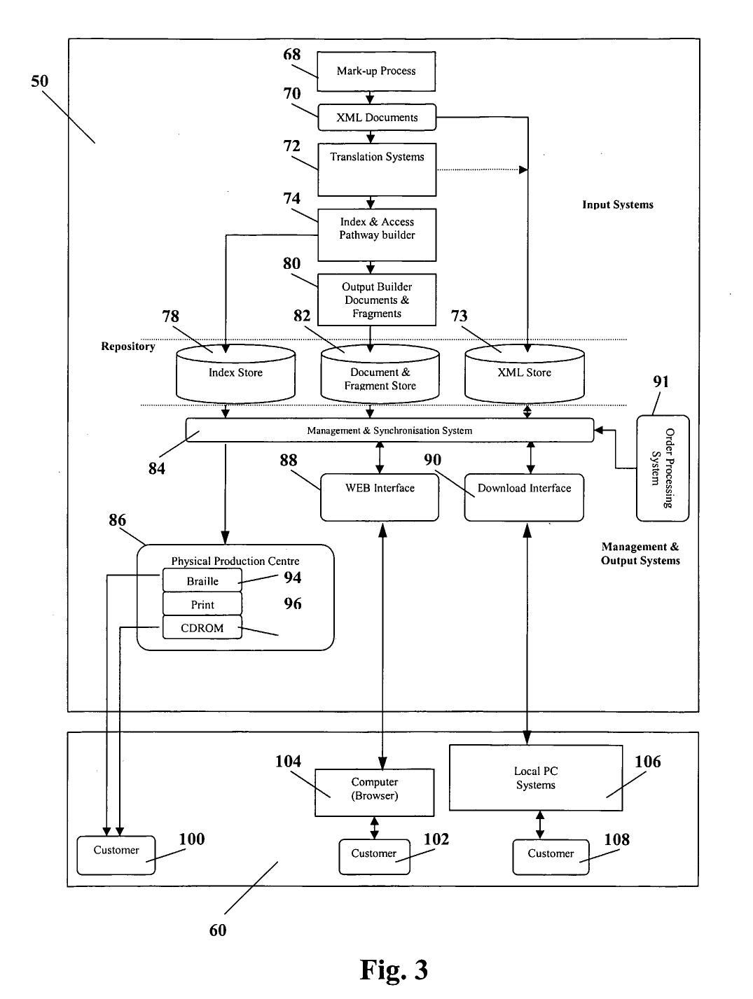

FIGS. 3, 4 and 5 are schematic diagrams that embody the arrangements of both FIGS. 1 and 2.

Building index lists and access pathways

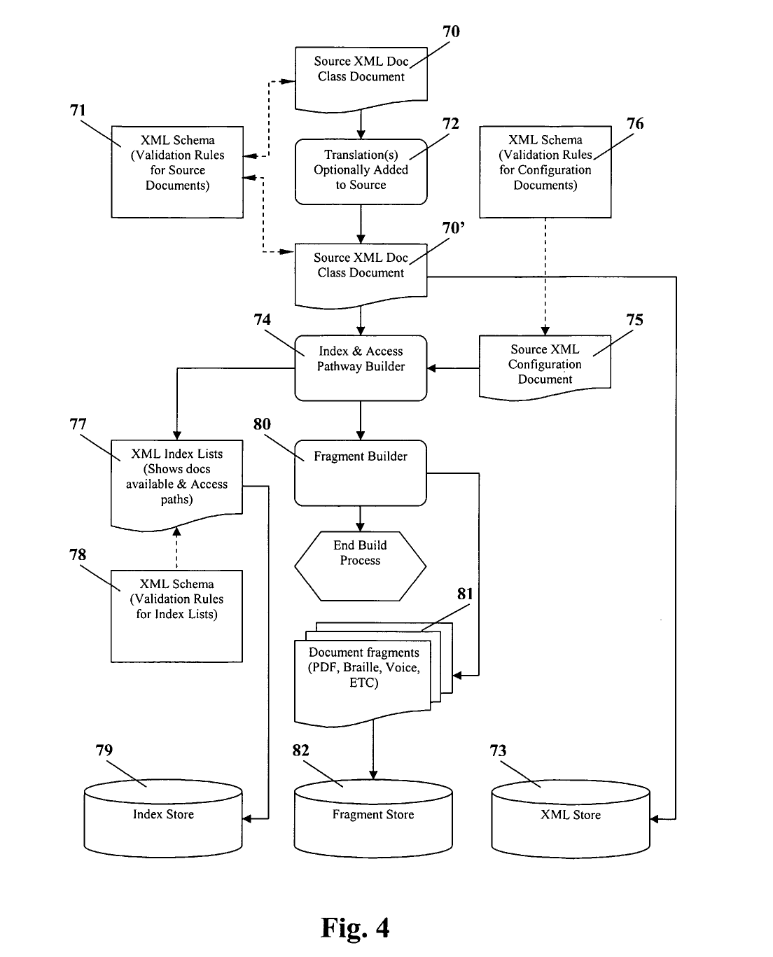

Turning specifically to FIG. 3, a document server 50 and a reproduction server 60 are shown. Sourced or input documents are subject to a mark-up process 60 to take marked-up XML form 70 in accordance with a defined class schema. As shown particularly in FIG. 4, a marked-up document 70 must be validated against a set of rules/schema 71 for the particular class of document. The source document can be input to the mark-up process 68 by any convenient means, including a foreign system integration, manual mark-up or form-based entry.

For Braille-form mark-up, character strings that need to be treated differently in Braille should be separately tagged and identified. An example is a foreign word that will be spelled out in Braille 1. Information like phone numbers and web addresses that may be treated differently in the different versions of Braille are likely to be tagged, so that these character strings can be rendered into a standard form more easily (eg. phone numbers with area codes can be written in several different formats and the actual number may or may not have spaces in it). Images and diagrams need to be annotated for the visually impaired, as will be described below.

If a document is to be offered in a different language to the original, then the marked-up form of document is actively processed by a translation system 72 in response to a customer request. The translation will depend on the document type and importance. Certain documents like invoices, bank statements and credit card statements consist of a template into which the content of the document is inserted. The content of the documents often contain largely numeric information (which does not need language translation), part or product names (which do not need language translation) or single words or phrases that can often be machine translated. If the documents contain only numerical, part or product names in the content, then simply translating the template will translate the document. If the template constructed so that the information in the template is called from a database, and if the calls to the database include the language, then these documents can be automatically translated at the request of the user. Other information in the invoice can be machine translated or if the information is say standard advertising information, then it can be manually translated and temporarily added to the template.

Other documents can be machine translated. More valuable documents (such as legal document or contracts) may be translated manually. The most valuable documents can be manually translated and manually verified by an independent translator. For manual translation of documents a work flow process will be instituted for tracking the manual translation of documents.

The marked-up documents 70, 70′ are then stored in an XML repository 73.

An index and access pathway builder 74 uses an XML configuration document 75, in turn based on an XML schema 76 providing validation rules, to configure an application that will build an XML document specific to each customer containing a list of all the documents available for a particular customer: the Index list 77. The index list 77 provides various ways for the customer to access those documents (ie. the access paths) determined by an XML schema 78. An XML index list 77 allows searching of, and navigation to any fragments defined in the configuration file 75 which generates and defines the granularity of any fragments. Index documents thus generated are stored in an index store 79.

Consider the following example XML code for a ‘bank statement’ class of document 70:

```
<?xml version=“1.0” encoding=“UTF-8”?>
<PBPDoc xmlns=“http://tempuri.org/BankStatement.xsd”
xmlns:xsi=“http://www.w3.org/2001/XMLSchema-instance”
xsi:schemaLocation=“http://tempuri.org/BankStatement.xsd
E:\vsprojects\VoicePatent\XML\BankStatement.xsd”>
  <Reciever>
    <Name>Mr C Stephen</Name>
    <address>21 Smith St</address>
    <City>Blacktown</City>
    <State>NSW</State>
    <PostCode>2615</PostCode>
  </Reciever>
  <Identification>
    <AccountNO>14062347</AccountNO>
    <BSBNO>123 789</BSBNO>
    <StatemmentNO>17</StatemmentNO>
    <StatementDate>2004-03-21</StatementDate>
    <PageNO>1</PageNO>
  </Identification>
  <Summary>
    <AccountNO>14062347</AccountNO>
    <AccontName>Business Account 1</AccontName>
    <BalanceOpen>250251.89</BalanceOpen>
    <BalanceClose>240789.92</BalanceClose>
    <TotalCredit>15893.73</TotalCredit>
    <TotalDebit>25355.70</TotalDebit>
  </Summary>
  <Transactions>
    <TRX TRXSign=“DEBIT”>
      <TRXDate>2004-03-17</TRXDate>
      <TRXDesc>Wages</TRXDesc>
      <TRXAmount>25355.70</TRXAmount>
      <TRXBalance>224896.19</TRXBalance>
    </TRX>
    <TRX TRXSign=“CREDIT”>
      <TRXDate>2004-03-19</TRXDate>
      <TRXDesc>Deposit ARC</TRXDesc>
      <TRXAmount>15,893.73</TRXAmount>
      <TRXBalance>240789.92</TRXBalance>
    </TRX>
  </Transactions>
  <Information>
    <Note>Effective April 30 a $1.00 charge will apply for each
business account transaction</Note>
  </Information>
</PBPDoc>
```

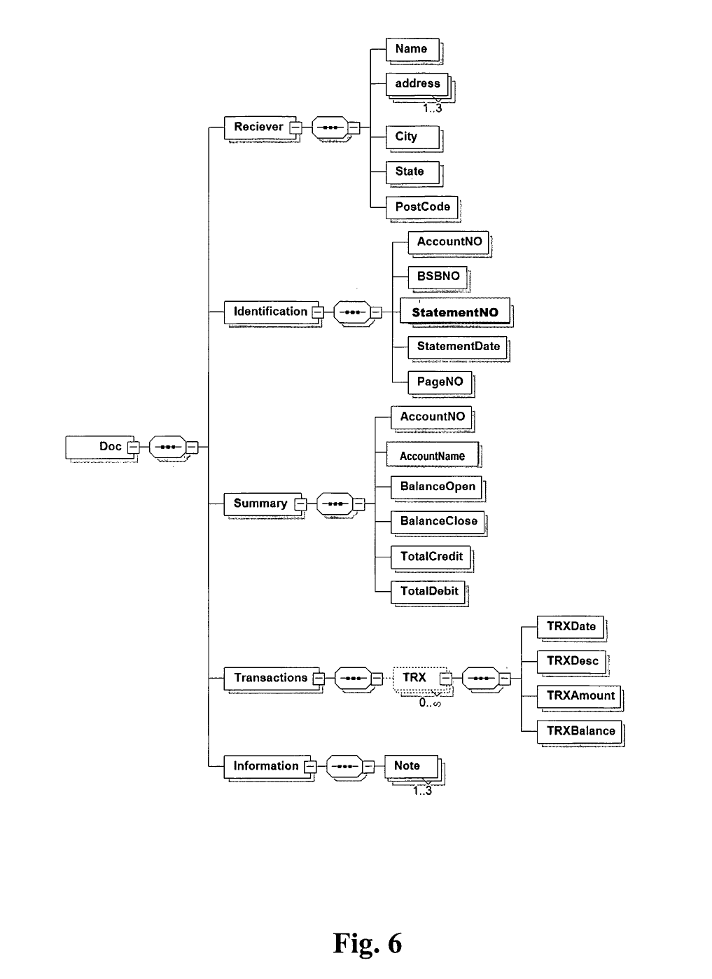

FIG. 6 shows a corresponding XML schema 71 for the ‘bank statement’ class of document.

As a separate example, consider an example marked-up XML file for a ‘book’ class of document 70:

```
<pbp-book xmlns:xsi=“http://www.w3.org/2001/XMLSchema-instance”
xsi:noNamespaceSchemaLocation=“E:\schemas\pbpbook_04.xsd”>
  <pbp-meta>
    <pbp-info schema-name=“pbp-book04.xsd” schema-rev=“4.01” file-
name=“A Brief History of Time.xml” tag-date=“2003-08-25” tag-
operator=“canberra” book-title=“A Brief History of Time” book-
type=“PBPress Novel” publication-status=“NOT FOR PUBLICATION”
copyright-status=“IN COPYRIGHT”/>
  </pbp-meta>
  <pbp-front>
    <cover>
      <construction-model>
        <c-title>A Brief History of Time</c-title>
        </author-list>
          <c-author>Stephen W Hawking</c-author>
        </author-list>
        <c-category>Non-Fiction, Science</c-category>
        <c-section>
          <cs-head>
            <title>A Brief Hostory of Time</title>
          </cs-head>
          <cs-body>
            <upara>This book has sold more copies that any non-
religious book ever printed, unfortunately most of the people who bought
it can't understand anything beyond the introduction.</upara>
          </cs-body>
        </c-section>
        <c-image page=“front” image-url=“e:\images\xx.jpg”>
          <voice-description>
            <para>this is a pretty picture of a clock</para>
          </voice-description>
        </c-image>
        <c-ISBN edition-value=“35689 78221”/>
      </construction-model>
    </cover>
    <title-block>
      <book-title>A Brief History of Time</book-title>
      <author>
        <first-name>Stephen </first-name>
        <other-name>W </other-name>
        <last-name>Hawking </last-name>
      </author>
    </title-block>
    <intro-block>
      <intro type=“foreword”>
        <intro-title>FOREWARD</intro-title>
        <body>
          <upara>I didn't write a foreword to the original edition of
A Brief History of Time. That was done by <emphasis type=”italics”>Carl
Sagan.</emphasis> Instead, I wrote a short piece titled
“Acknowledgments” in which I was advised to thank everyone. Some of
the foundations that had given me support weren't too pleased to have
been mentioned, however, because it led to a great increase in
applications.</upara>
        </body>
        <sigblock>
          <sig-name>Stephen W Hawking</sig-name>
        </sigblock>
      </intro>
    </intro-block>
  </pbp-front>
  <pbp-body>
    <section type=“chapter”>
      <head>
        <section-num>CHAPTER 1</section-num>
        <section-title>OUR PICTURE OF THE UNIVERSE
        </section-title>
      </head>
      <body>
        <upara>A well-known scientist (some say it was Bertrand
Russell) once gave a public lecture on astronomy. He described how the
earth orbits around the sun and how the sun, in turn, orbits around the
center of a vast collection of stars called our galaxy. At the end of
the lecture, a little old lady at the back of the room got up and said:
“What you have told us is rubbish. The world is really a flat plate
supported on the back of a giant tortoise.” The scientist gave a
superior smile before replying, “What is the tortoise standing on.”
“You're very clever, young man, very clever,” said the old lady. “But
it's turtles all the way down!”</upara>
      </body>
    </section>
  </pbp-body>
</pbp-book>
```

Configuration files configure the software applications to provide the necessary functionality. An example XML configuration file 75 for the client index and access pathway builder 74 for a ‘bank statement’ class file is:

```
<?xml version=“1.0” encoding=“UTF-8“?>
<AccessBuilder xmlns=“http://tempuri.org/Builder.xsd”
xmlns:xsi=“http://www.w3.org/2001/XMLSchema-instance”
xsi:schemaLocation=“http://tempuri.org/Builder.xsd
E:\vsprojects\VoicePatent\XML\Builder.xsd”>
<DocClass>Bank Statement</DocClass>
    <AccessItem>
        <PathClass>Address</PathClass>
        <PathName>Reciever</PathName>
    </AccessItem>
    <AccessItem>
        <PathClass>AccountInfo</PathClass>
        <PathName>Identification</PathName>
    </AccessItem>
    <AccessItem>
        <PathClass>TRXSummary</PathClass>
        <PathName>Summary</PathName>
    </AccessItem>
    <AccessItem>
        <PathClass>ProviderNote</PathClass>
        <PathName>Information</PathName>
    </AccessItem>
    <AccessItem>
        <PathClass>TRXGroup</PathClass>
        <PathName>Transactions</PathName>
    </AccessItem>
    <AccessItem>
        <PathClass>TRXBank</PathClass>
        <PathName>TRX</PathName>
    </AccessItem>
</AccessBuilder>
```

The configuration file 75 for the ‘book’ class of document is:

```
<?xml version=“1.0” encoding=“UTF-8”?>
<pbpVoiceConfig xmlns=“http://tempuri.org/VoiceConfig.xsd”
xmlns:xsi=“http://www.w3.org/2001/XMLSchema-instance”
xsi:schemaLocation=“http://tempuri.org/VoiceConfig.xsd
E:\vsprojects\voicePatent\XML\VoiceConfig.xsd”>
  <pbpSchemaID>STDBOOK</pbpSchemaID>
  <pbpProcessID>DAISYBOOK</pbpProcessID>
  <VCMapItem>
    <pbpTagName>upara</pbpTagName>
    <pbpTagDesc>Un-numbered Para</pbpTagDesc>
    <htmTagMap>p</htmTagMap>
    <htmJustify/>
    <pbpActionMap>P</pbpActionMap>
    <pbpProcessInclude>include</pbpProcessInclude>
  </VCMapItem>
  <VCMapItem>
    <pbpTagName>npara</pbpTagName>
    <pbpTagDesc>Numbered Para</pbpTagDesc>
    <htmTagMap>p</htmTagMap>
    <htmJustify/>
    <pbpActionMap>P</pbpActionMap>
    <pbpProcessInclude>include</pbpProcessInclude>
  </VCMapItem>
  <VCMapItem>
    <pbpTagName>author</pbpTagName>
    <pbpTagDesc>Author Name</pbpTagDesc>
    <htmTagMap>h2</htmTagMap>
    <htmJustify>center</htmJustify>
    <pbpActionMap>O</pbpActionMap>
    <pbpProcessInclude>include</pbpProcessInclude>
  </VCMapItem>
  <VCMapItem>
    <pbpTagName>section-num</pbpTagName>
    <pbpTagDesc>Section Number</pbpTagDesc>
    <htmTagMap>h3</htmTagMap>
    <htmJustify>center</htmJustify>
    <pbpActionMap>T</pbpActionMap>
    <pbpProcessInclude>include</pbpProcessInclude>
  </VCMapItem>
  <VCMapItem>
    <pbpTagName>section-title</pbpTagName>
    <pbpTagDesc>Section Title</pbpTagDesc>
    <htmTagMap>h3</htmTagMap>
    <htmJustify>center</htmJustify>
    <pbpActionMap>T</pbpActionMap>
    <pbpProcessInclude>include</pbpProcessInclude>
  </VCMapItem>
  <VCMapItem>
    <pbpTagName>book-title</pbpTagName>
    <pbpTagDesc>Book Title</pbpTagDesc>
    <htmTagMap>h2</htmTagMap>
    <htmJustify>center</htmJustify>
    <pbpActionMap>T</pbpActionMap>
    <pbpProcessInclude>include</pbpProcessInclude>
  </VCMapItem>
  <VCMapItem>
    <pbpTagName>intro-title</pbpTagName>
    <pbpTagDesc>Intro Title</pbpTagDesc>
    <htmTagMap>h3</htmTagMap>
    <htmJustify>center</htmJustify>
    <pbpActionMap>T</pbpActionMap>
    <pbpProcessInclude>include</pbpProcessInclude>
  </VCMapItem>
  <VCMapItem>
    <pbpTagName>defterm</pbpTagName>
    <pbpTagDesc>Defined Term</pbpTagDesc>
    <htmTagMap>p</htmTagMap>
    <htmJustify/>
    <pbpActionMap>O</pbpActionMap>
    <pbpProcessInclude>include</pbpProcessInclude>
  </VCMapItem>
  <VCMapItem>
    <pbpTagName>sig-name</pbpTagName>
    <pbpTagDesc>Signature Name</pbpTagDesc>
    <htmTagMap>h4</htmTagMap>
    <htmJustify/>
    <pbpActionMap>O</pbpActionMap>
    <pbpProcessInclude>include</pbpProcessInclude>
  </VCMapItem>
  <VCMapItem>
    <pbpTagName>sig-position</pbpTagName>
    <pbpTagDesc>Signature Position</pbpTagDesc>
    <htmTagMap>h4</htmTagMap>
    <htmJustify/>
    <pbpActionMap>O</pbpActionMap>
    <pbpProcessInclude>include</pbpProcessInclude>
  </VCMapItem>
  <VCMapItem>
    <pbpTagName>sig-date</pbpTagName>
    <pbpTagDesc>Signature Date</pbpTagDesc>
    <htmTagMap>h4</htmTagMap>
    <htmJustify/>
    <pbpActionMap>O</pbpActionMap>
    <pbpProcessInclude>include</pbpProcessInclude>
  </VCMapItem>
  <VCMapItem>
    <pbpTagName>cover</pbpTagName>
    <pbpTagDesc>Complete Cover</pbpTagDesc>
    <htmTagMap/>
    <htmJustify/>
    <pbpActionMap>N</pbpActionMap>
    <pbpProcessInclude>exclude</pbpProcessInclude>
  </VCMapItem>
</pbpVoiceConfig>
```

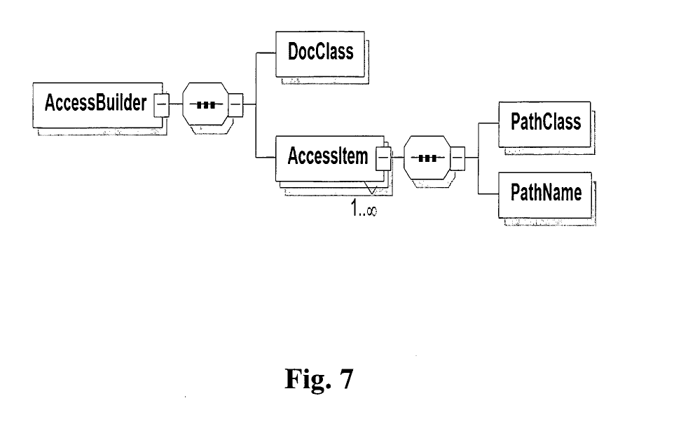

The XML schema 76 providing validation rules for the configuration files is shown in FIG. 7.

Access pathways can be applied to any schema, and there is an ability to apply different access paths to the same element (eg. transactions and transaction item). Additionally, it is possible to use only a containing element (ie. a leaf node or one that does not contain lower level elements becomes the container).

Consider the following index list 77 for a particular customer:

```
<?xml version=“1.0” encoding=“UTF-8”?>
<PBPIndex xmlns=“http://tempuri.org/index.xsd”
xmlns:xsi=“http://www.w3.org/2001/XMLSchema-instance”
xsi:schemaLocation=“http://tempuri.org/index.xsd
E:\vsprojects\VoicePatent\XML\index.xsd”>
  <IDXGroup Name=“Bank Statement”>
    <IDXItem>
      <DocClass>Bank Statement</DocClass>
      <ITMIdentifier>A12345</ITMIdentifier>
      <ITMSender>Westpac Corp</ITMSender>
      <ITMReceiver>CCStephen</ITMReceiver>
      <ITMTitle>Statement - Savings Account</ITMTitle>
      <ITMDate>2004-04-15</ITMDate>
      <ITMOriginator>Westpac Corp</ITMOriginator>
      <ITMAccess>
        <ITMPath>
          <PathClass>Address</PathClass>
          <PathName>Reciever</PathName>
        </ITMPath>
        <ITMPath>
          <PathClass>AccountInfo</PathClass>
          <PathName>Identification</PathName>
        </ITMPath>
        <ITMPath>
          <PathClass>TRXSummary</PathClass>
          <PathName>Summary</PathName>
        </ITMPath>
        <ITMPath>
          <PathClass>ProviderNote</PathClass>
          <PathName>Information</PathName>
        </ITMPath>
        <ITMPath>
          <PathClass>TRXGroup</PathClass>
          <PathName>Transactions</PathName>
        </ITMPath>
        <ITMPath>
          <PathClass>TRXBank</PathClass>
          <PathName>TRX</PathName>
        </ITMPath>
      </ITMAccess>
    </IDXItem>
    <IDXItem>
      <DocClass>Bank Statement</DocClass>
      <ITMIdentifier>C567823</ITMIdentifier>
      <ITMSender>CCStephen</ITMSender>
      <ITMReceiver>CCStephen</ITMReceiver>
      <ITMTitle>Statement - Business Account</ITMTitle>
      <ITMDate>2004-04-17</ITMDate>
      <ITMOriginator>Commonwealth Bank</ITMOriginator>
      <ITMAccess>
        <ITMPath>
          <PathClass>Address</PathClass>
          <PathName>Reciever</PathName>
        </ITMPath>
        <ITMPath>
          <PathClass>AccountInfo</PathClass>
          <PathName>Identification</PathName>
        </ITMPath>
        <ITMPath>
          <PathClass>TRXSummary</PathClass>
          <PathName>Summary</PathName>
        </ITMPath>
        <ITMPath>
          <PathClass>ProviderNote</PathClass>
          <PathName>Information</PathName>
        </ITMPath>
        <ITMPath>
          <PathClass>TRXGroup</PathClass>
          <PathName>Transactions</PathName>
        </ITMPath>
        <ITMPath>
          <PathClass>TRXBank</PathClass>
          <PathName>TRX</PathName>
        </ITMPath>
      </ITMAccess>
    </IDXItem>
  </IDXGroup>
  <IDXGroup Name=“Telephone Account”>
    <IDXItem>
      <DocClass>Telephone Account</DocClass>
      <ITMIdentifier>T43215</ITMIdentifier>
      <ITMSender>Telstra Corp</ITMSender>
      <ITMReceiver>CCStephen</ITMReceiver>
      <ITMTitle>Telephone 9133 3487</ITMTitle>
      <ITMDate>2004-03-31</ITMDate>
      <ITMOriginator>Telstra Corp</ITMOriginator>
      <ITMAccess>
        <ITMPath>
          <PathClass>Document</PathClass>
          <PathName>PBPDoc</PathName>
        </ITMPath>
      </ITMAccess>
    </IDXItem>
  </IDXGroup>
  <IDXGroup Name=“Documents April 2004”>
    <IDXItem>
      <DocClass>Bank Statement</DocClass>
      <ITMIdentifier>A12345</ITMIdentifier>
      <ITMSender>Westpac Corp</ITMSender>
      <ITMReceiver>CCStephen</ITMReceiver>
      <ITMTitle>Statement - Savings Account</ITMTitle>
      <ITMDate>2004-04-15</ITMDate>
      <ITMOriginator>Westpac Corp</ITMOriginator>
      <ITMAccess>
        <ITMPath>
          <PathClass>Address</PathClass>
          <PathName>Reciever</PathName>
        </ITMPath>
        <ITMPath>
          <PathClass>AccountInfo</PathClass>
          <PathName>Identification</pathName>
        </ITMPath>
        <ITMPath>
          <PathClass>TRXSummary</PathClass>
          <PathName>Summary</PathName>
        </ITMPath>
        <ITMPath>
          <PathClass>ProviderNote</PathClass>
          <PathName>Information</PathName>
        </ITMPath>
        <ITMPath>
          <PathClass>TRXGroup</pathClass>
          <PathName>Transactions</pathName>
        </ITMPath>
        <ITMPath>
          <PathClass>TRXBank</PathClass>
          <PathName>TRX</pathName>
        </ITMPath>
      </ITMAccess>
    </IDXItem>
    <IDXItem>
      <DocClass>Bank Statement</DocClass>
      <ITMIdentifier>C567823</ITMIdentifier>
      <ITMSender>CCStephen</ITMSender>
      <ITMReceiver>CCCStephen</ITMReceiver>
      <ITMTitle>Statement - Business Account</ITMTitle>
      <ITMDate>2004-04-17</ITMDate>
      <ITMOriginator>Commonwealth Bank</ITMOriginator>
      <ITMAccess>
        <ITMPath>
          <PathClass>Address</PathClass>
          <PathName>Reciever</pathName>
        </ITMPath>
        <ITMPath>
          <PathClass>AccountInfo</pathClass>
          <PathName>Identification</PathName>
        </ITMPath>
        <ITMPath>
          <PathClass>TRXSummary</pathClass>
          <PathName>Summary</pathName>
        </ITMPath>
        <ITMPath>
          <PathClass>ProviderNote</PathClass>
          <PathName>Information</PathName>
        </ITMPath>
        <ITMPath>
          <PathClass>TRXGroup</PathClass>
          <PathName>Transactions</PathName>
        </ITMPath>
        <ITMPath>
          <PathClass>TRXBank</PathClass>
          <PathName>TRX</PathName>
        </ITMPath>
      </ITMAccess>
    </IDXItem>
    <IDXItem>
      <DocClass>Telephone Account</DocClass>
      <ITMIdentifier>T43215</ITMIdentifier>
      <ITMSender>Telstra Corp</ITMSender>
      <ITMReceiver>CCStephen</ITMReceiver>
      <ITMTitle>Telephone 9133 3487</ITMTitle>
      <ITMDate>2004-03-31>/ITMDate>
      <ITMOriginator>Telstra Corp</ITMOriginator>
      <ITMAccess>
        <ITMPath>
          <PathClass>Document</PathClass>
          <PathName>PBPDoc</PathName>
        </ITMPath>
      </ITMAccess>
    </IDXItem>
  </IDXGroup>
</PBPIndex>
```

This index document holds two ‘bank statement’ records and one ‘telephone account’ record. Each access path consists of a block of one or more elements contained by a single element; these containing elements are the identifiers in the “ITMPath” elements of the index list.

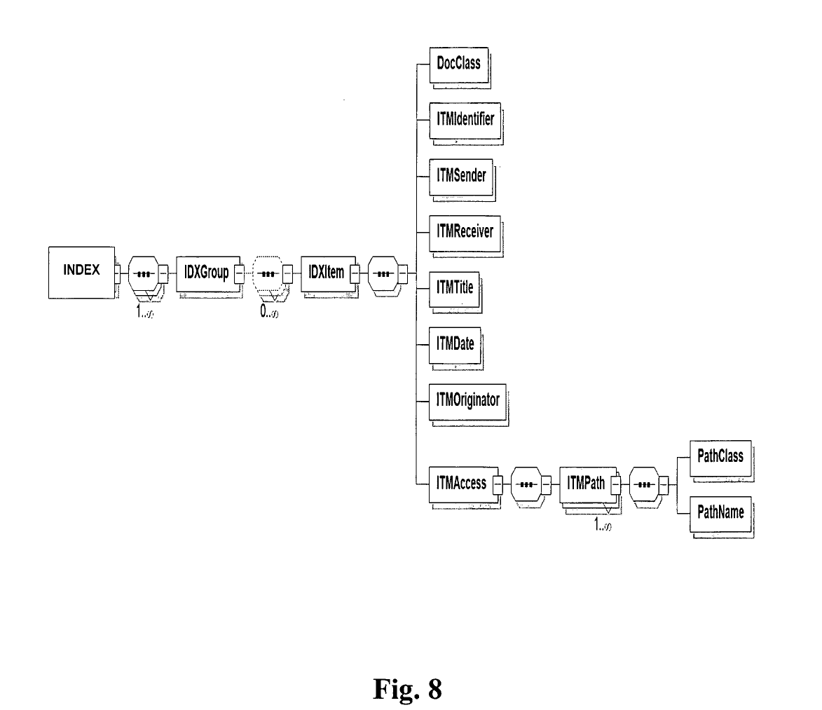

Reference is made to FIG. 8, showing a corresponding XML schema 78 for the index list and the access paths available to each document.

Building Fragments

A fragment builder 80 has knowledge of the fragments for a particular document, and utilises known application programs to convert each fragment into each of the requested supported forms. The fragments can also include formatting options available to customers (as described below).

One objective is to provide disabled people with the ability to deal with their documents in an efficient manner in their chosen form. It may not apply for all customer document reports. This is described as a ‘navigation’ ability, in that a document can be navigated by its fragments.

For each class of document, analysis and mapping must be carried out to clearly identify the significant blocks of data requiring presentation to the user through navigable means. Consider the bank statement document described above. The following significant blocks of information are needed:
Period Information
   The period covered by the statement
Account Information
   Account identification information such as the number
Personal Information
   Name, address, etc information presented on the statement
Transaction Information
   The block container of all transactions in the period
      Individual Transactions—each transaction within the transaction block
Balance information
   The starting and ending balances
Summary Information
   The summary of debits and credits
Message Information
   A special message or advertising material provided on the statement

Indeed, these fragments are evident in the ‘bank statement’ XML index list 77 given above.

Relationships and Schema Relating to Fragment Production

The following example is an audio fragment, but it applies equally to any fragment. Firstly, it is important that the processing systems be able to clearly identify the elements of the schema that contain actual text that needs to be “spoken”. A schema may contain hundreds or even thousands of elements, some mandatory, others optional or dependant on higher level elements in the element “tree” a lesser number of the elements will encapsulate actual text. For this example, assume a schema holds 100 elements, 20 of those elements can contain text, the remaining 80 provide the context in which those text elements are used—the ancestry of the text. Thus it is important in using the chosen schema for the system to be able to identify which elements contain text and which elements provide the context of the text.

This classification of elements is further complicated by the fact that some elements can contain both text and lower level elements which also contain text, called a mixed model element.

An example of a mixed model is emphasis within a paragraph

<upara>The quick brown fox jumps over the lazy dog.</upara>

<upara>The quick brown fox <emphasis type=’Italic’>jumps
over</emphasis> the lazy dog.</upara>

It is obvious that the second model is more complex as we cannot simply speak the ‘upara’ element and the ‘emphasis’ element as there would then be two sound blocks, which in all practicality does not work.

The approach is to ignore the mixed element tags (emphasis) and speak all the text contained in the upara element, including that enclosed in the emphasis element, but not the actual tag itself (<emphasis type=‘Italic’>). This entails the need to clearly identify:
Elements that provide context information
Elements that contain text
Elements that are used within mixed model elements

Although it is unlikely that the headings would be spoken differently (although it would be possible to use a different voice for each or tone or even volume for the hard of hearing), it is currently unlikely that this would happen.

Component Identification

Analysis of the chosen schema must be performed to clearly identify the elements that encapsulate complete blocks of text.

Definitions:

complete block of text—blocks of text that need to be read as a single stream, and is the smallest navigable unit within a voice document (eg. in a simple audio book, this could be a chapter, in a Daisy book, more likely a paragraph.).
granularity—the process of deciding the size of the block of text to be read as a single unit, coarse granularity may refer to reading the entire document or a chapter as a single unit, fine granularity may refer to reading the individual paragraphs as a single unit.

Finer granularity enables more precise navigation and searching.

Complete blocks of text may contain in-line or nested tags, typically these would relate to emphasis or such like, but in reality, all text contained within the root element of the document could be read in a single stream (ie. the complete book). Actual tags within the text block (but not their text content) need to be ignored in the reading process and this applies during recursion of the nesting process.

Where in-line tags occur, or structural tags are treated as in-line tags (such as in treating a complete chapter as a single block of text), it is ensured that removal or ignoring of the inline tags preserves white space and does not cause words to be joined.

All elements that are not those encapsulating complete blocks of text are either:
a. Inline elements or those regarded as inline elements due to the selection of corse granularity (lower level elements than the elements containing complete blocks of text)—these will be ignored.
b. Structural elements (higher level elements than the elements containing complete blocks of text)—these will provide context for the text elements
   Element Types & Usage

The three element types described above are used in the following manner
i. Inline—ignored
ii. Structural—provide context for the text elements (via use of ancestors)
iii. Text—contains the text to be read
   Element Ancestry

Although ancestry is less important in voice generation that in say the production of printed matter, it still has some significance and the same basic rules apply. Ancestry is important as a heading tag may be used in both the book title and the chapter title, same element—different ancestry (context). The context of the element is used in creation of the navigation component for the DAISY book. The complete ancestry of an element is typically not of interest, rather just whether element X is anywhere in the ancestry. Element X would normally be unique to a single path and sufficient to identify the context.

The fragment builder 80 thus generates—using standard software applications—output files 81 of the appropriate type for each form the source document can take: for example, .pdf for print, MP3 for audio, Braille ASCII for Braille and any convenient file type (eg. MS Reader™) for E-book. These are stored in the fragment store 82.

C. Reproduction

Reproduction is under the control of the management and synchronisation system 84. Both complete rendered documents in the chosen form and rendered document fragments of the chosen form for each navigable component defined by the pathway builder 74 can be reproduced. The chosen reproduction form is achieved by an appropriate mapping process. In one embodiment the following set of applications can be used:

Voice generation system—generates DAISY, MP3 and CD audio forms.

The process is as follows
Wav file generation of each navigable fragment: for this process the prototype Microsoft MAPI™ and AT&T Voices™ software products are used.
MP3 conversion of each fragment: for this process, the shareware/freeware LAME (LAME v.3.96 of 11 Apr. 2004, available to download from http://lame.sourceforge.net) is used.
Author the collection of DAISY files: for this process, a tool based on the access path methods and mapping process is used to output a file to the DAISY format is used.
   Braille Production Process

Braille production is dependant on two principal driving factors. The first is the selected contraction table which is usually based on the language (US English Braille. UK English Braille, German Braille, etc). The second is the selection of the target Braille code which maps the characters of the language to the dot based Braille code. Although typically English words would have English contractions and English codes (also German->German->German) English words could be written with German contractions and German codes so that a German Braille reader who could speak English could read the English words without having to learn English Braille codes.

Braille contractions are driven by large translation tables (one for each language supported). These tables contain the word and the Braille contracted word in the target language. There are rules as to where contractions may be applied, for example some words may not have ending contractions applied if immediately followed by punctuation, etc. In this situation the word will be entered several times in the table, with the punctuation mark appended to the word in the additional entries. In the following hypothetical example, the characters “ing” are replaced in the word “running” but not in the word “running.” XML and table fragments illustrate this.

| | |
|---|---|
| Running | replace <Braille contracted form> |
| running. | no replace |
| running! | no replace |

<xmlfragment>
<para>The boy was running at the beach. The boy left the room
running.</para>
<./xmlfragment>
<xmlfragment>
<para>The <Braille contraction=true>boy </Braille>was <Braille
contraction=true>running</Braille>at the beach. The boy left the
room <Braille
contraction=false>running.</Braille></para>
</xmlfragment>

In reality all words in the <para> will be tagged with either true or false, but in this example for clarity we have tagged only “running” and “boy”. Words that are not tagged do not appear in the translation table, and will be written to an exception file for either addition to the table and reprocessing or they may be handled as Braille 1. The final step is processing to Braille output.

E-book Generation Process

Any convenient text conversion software application can be used (eg. Acrobat Reader™).

The document management and synchronisation system 84 manages and tracks the documents, fragments, XML documents and indexes. The management and synchronisation system 84 interacts with three output interfaces: a physical production interface 86, a web interface 88 and a download interface 90.

Physical Production

The physical production centre 86 uses the pre-built output documents and document fragments to produce physical media to delivered by suitable means to a customer 100. The physical production centre 86 produces the chosen form of either a Braille document 94, a printed document 96, or a storage medium such as a CDROM 98.

The web interface 88 employs web pages to call server functionality to deliver electronic files to the client in the following forms:
output documents;
output fragments;
index functionality;
searching; and
interactive forms.

The web interface 88 is accessed by the customer 102 by any convenient browser application 104.

The download interface 90 is a simple web-service or other transfer mechanism to move documents to a customer PC for access purposes. This interface 90 is active when a customer chooses to synchronise documents over the internet. The download interface 90 thus communicates with local PC systems 106, under the control of the customer 108.

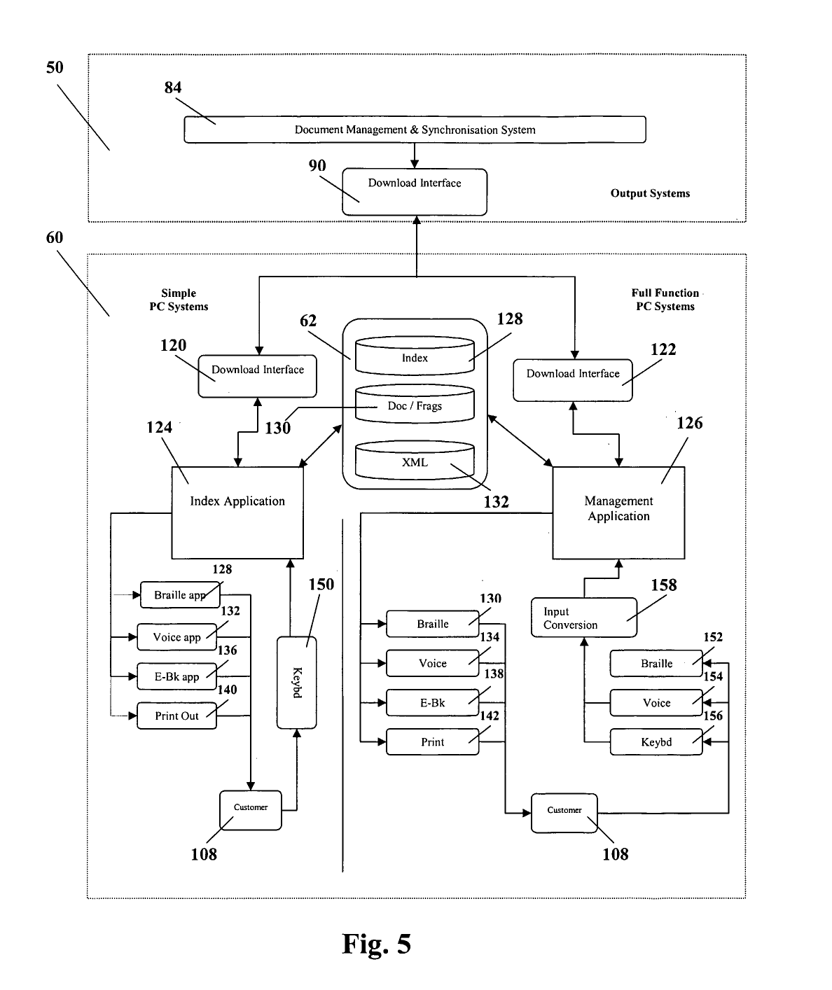

Turning now to FIG. 5, the management and synchronisation system 84 and download interface 90 of the document server processes 50 are shown. The user server processes 60 correspond broadly with the local PC systems 106 and user 108 shown in FIG. 3.

A download interface 120, 122 is provided for the simple PC system solution and the full-function PC system solution, respectively. A simple PC system solution has an index application 124, whereas a full-function PC system has a management application 126. In both cases the user's files are copied to the reproduction computer, including index files 128, output documents and fragments 130 and XML documents 132, in a common store 62.

The index application 124 has the ability to read and/or search the customer's index list, and search documents using the XML documents store 132 to present complete documents through a reader application.

The management application 126 has the ability to handle various forms of input other than a keyboard or helper application.

Four forms of output are provided. A Braille application 128, 130 generates a Braille document using any convenient commercial system, to be delivered to the user 108 in paper form by host or electronically for local printing or for use on a reader/keyboard device.

A voice application 132, 134 are generated as described above. Voice fragments are navigable using standard DAISY functionality giving limited levels of navigation through these classes of documents. One way to improve the navigability is to concatenate the index and access the pathways to create longer access pathways.

Having done this, the information can be mapped into a DAISY form. This approach delivers navigability in a third party product.

An E-book application 136, 138 can be achieved through the use of XSL(T) transformations.

Finally, a print application 140, 142 generates a PDF output file.

For these simple PC systems, a simple keyboard 150 can be interfaced with the index application 124. For the full-function PC system, a Braille input device 152, voice input device 154 and keyboard 156 can interface with an input conversion application 158, in-turn inputting to the management application 126.

Print Formatting

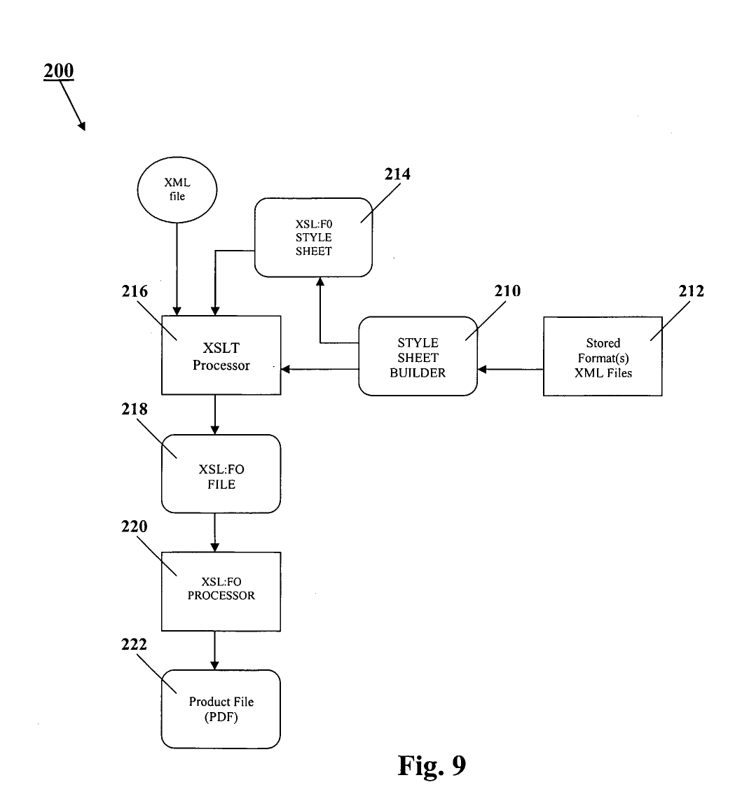

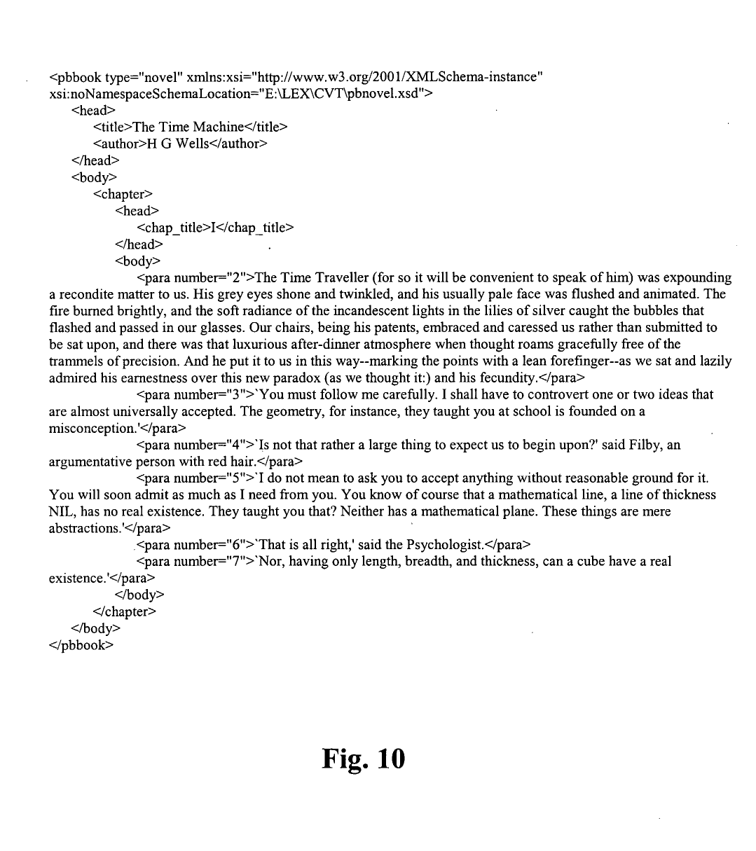

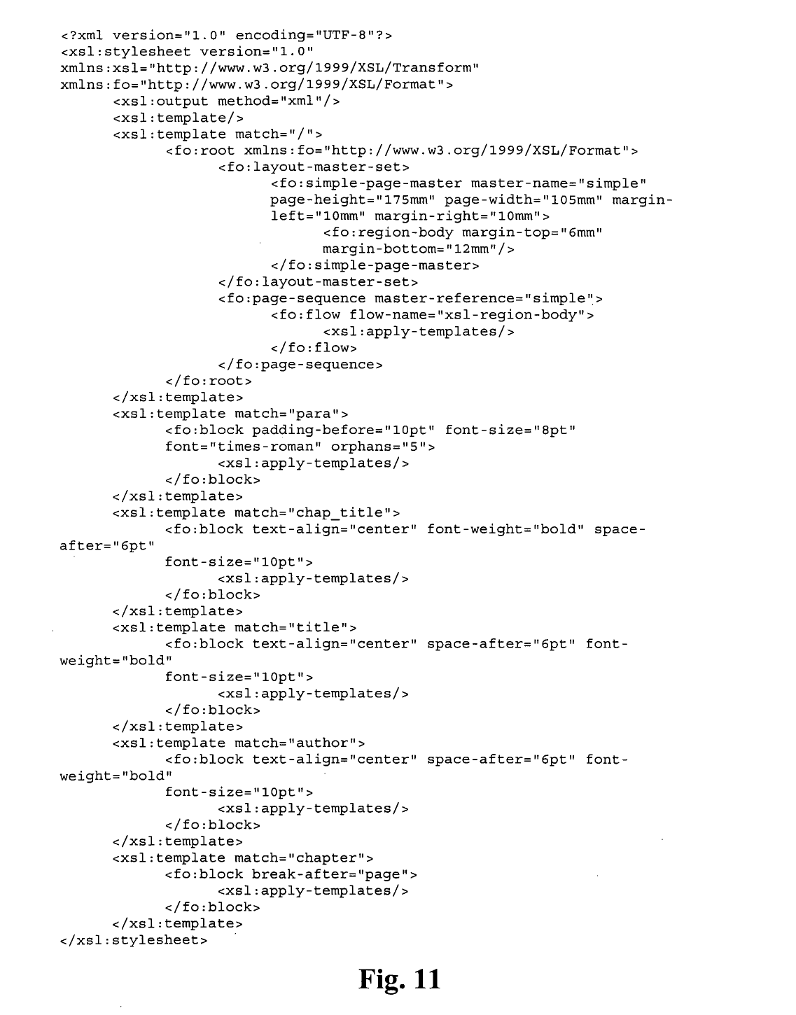

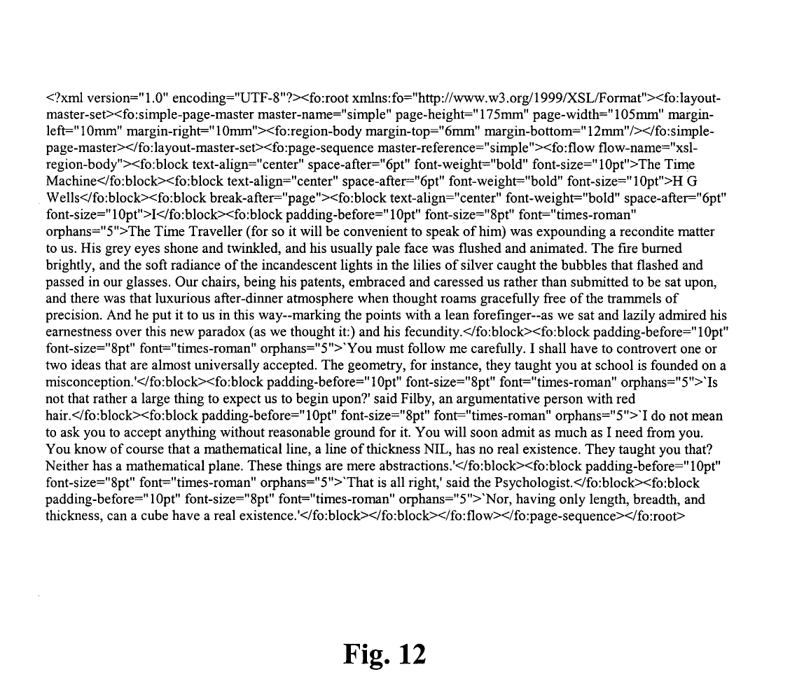

Referring now to FIG. 9, a chosen document format is produced by additional processes 200 on the document server 50. A Style Sheet Builder 210 uses an XML file 212 (shown in FIG. 10) defining the format (typically selected by the customer) to create an XSL:FO style sheet 214 (shown in FIG. 11). This style sheet 214 is then applied by the XSLT processor 216 to the XML document or fragment/s which corresponds to the document required by the customer from the repository 82 to produce an XSL:FO file 218 (shown in FIG. 12). The explicit flow information in the XML document captured in the mark-up cannot be modified by this process. When in final form, the XSL:FO file 216 is processed by the XSL:FO processor 220 to produce the document in a form ready for printing, in this case in PDF format 222.

D. Searching

Searching can be performed on the index 77 or on the whole document. The index is used for navigation to allow rapid retrieval of a document or fragment, and in addition, the index can be searched for content. Not all information need be in the index, and so the document can also be searched for context. In searching for a telephone number on a phone bill, the search could be restricted to the phone number in the transaction listing sections (ie. access pathway) finding a specific number called, because the information is provided in XML as well as in any user-requested format. In the case of presentment in any form, the functionality is available as the XML used to create the presented document is provided as a basis for searching in context, the choice of customer system will define how the result is presented. In the case of a simple storage solution (left-hand side of item 60 in FIG. 5), an indexer application is provided to the customer on the local PC 108.

This will only be able to present a complete document as the result of the search (ie. a phone bill, not a line on the bill). The full function system (right-hand side of item 60 in FIG. 5) or the online system 104 will be able to present just the line item fragments in the format required by the user (say a PDF or voice fragment).

E. Other Embodiments

Special Braille Mark-Up

Images can be represented in print and to a lesser extent in Braille. For example, a square can be represented as four lines intersecting lines of closely spaced Braille impressions forming a square. A pie chart can be represented as a circle of Braille impressions which are intersected by radii at appropriate points. A bar chart can similarly be represented as can a graph.

A program that can create regular images in print can also be used to create Braille representations at appropriate sizes for the reader.

With images represented in Braille, there are usually descriptions in Braille. These descriptions are usually manually created, as are the Braille images. These manual descriptions or annotations of the diagram can be used directly in Audio Books as well as Braille documents.

A standard text template be formed for regular images such as geometric shapes, pie or bar charts, graphs and other similar images, and variables can be automatically inserted in the mark-up process so that the particulars of that image can be correctly explained to the Braille reader.

A customer can create a Braille image representation and annotation simply by selecting the image type and inserting the variables to define the image. If an embossed image is required, the mark-up will generate the embossed image with the appropriate labels and insert the text of the variables in the annotation template text in a suitable format so that the Braille reader can quickly find out what the image refers to. This also can be applied to non English languages.

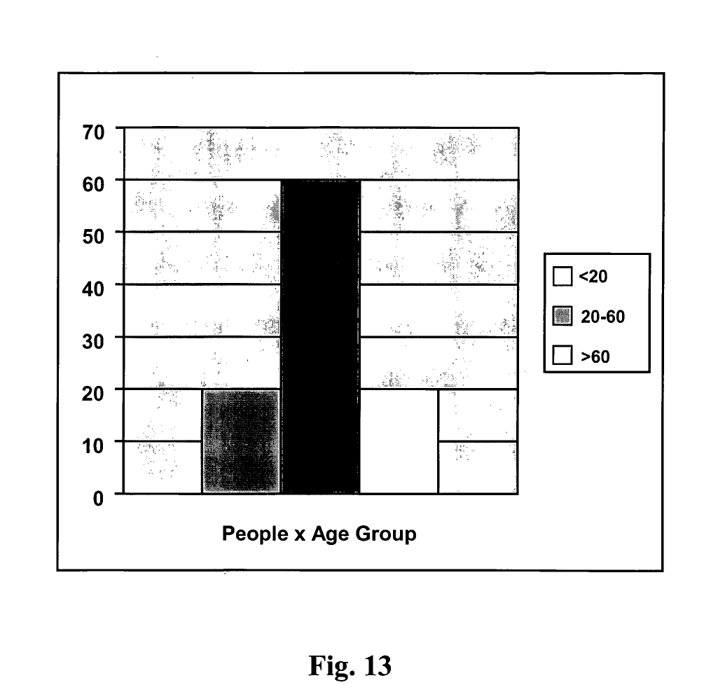

For example, a person wanting to create a Braille representation of a simple bar chart shown in FIG. 13. The Braille annotation may read as follows:
<Annotation>
This diagram is titled “People×Age Group”. The diagram is a bar chart. The vertical axis shows numbers of people. The bars horizontal axis shows age group categories. The bars are vertical. There are three bars in the diagram.
   Vertical Bar 1—Less than 20 years old. The number of people in bar 1 is 20.
   Vertical Bar 2—Between 20 and 60 years old. The number of people in bar 2 is 60.
   Vertical Bar 3—More than 60 years old. The number of people in bar 3 is 20.
<Annotation>

The variables to be filled in are:
Variable 1=Title
Variable 2=Diagram Type
Variable 3=Vertical Axis name
Variable 4=Horizontal Axis name
Variable 5=Direction of bars (vertical or horizontal)
Variable 6=Number of bars
Variable 6—the number of bars—will determine that there are 6 more variables representing the title and number of each of the three bars:
Variable 7=Title of bar 1
Variable 8=Size of bar 1
Variable 9=Title of bar 2
Variable 10=Size of bar 2
Variable 11=Title of bar 3

Variable 12=Size of bar 3

<Template>
This diagram is titled “<variable 1>”. The diagram is a <variable 2>. The
vertical axis shows <variable 3>. The horizontal axis shows <variable 4>.
The bars are <variable 5>. There are <variable 6> bars in the diagram.
Vertical Bar 1 - <variable 7>. The <variable 3> bar is <variable 8>.
Vertical Bar 2 - <Variable 9>. The <variable 3> bar is <variable 10>.
Vertical Bar 3 - <variable 11>. The <variable 3> bar is <variable 12>.
</Template>

The template may not include all of the visual information, such as the shading and horizontal lines shown in FIG. 13, as such information may be confusing to visually impaired people.

The same variables can be used to generate the Braille and also the typeset image of the diagram of FIG. 13.

Storage and Retrieval of Braille Images and Image Annotations

Sighted people can search for images from image categories and from descriptions of the images, and can locate possible images and then view the images to select the correct image. Using this technique, in addition to the original image being stored, an annotation of the image and a Braille representation of the image can be stored. In this way, someone who has created a Braille representation of an image of the map of Australia and annotated it can store the original image, the Braille representation of the image and the annotation, and make it available for other people to locate and use without having to redo this work.

Response Capability

The facility for customers to provide responses to documents is provided. For example, one form of document that is reproduced may be a questionnaire, and responses to the questions can be made by the customer in any desired form (supported by the customer computer), and stored on the document server for subsequent attention.

Invoice Classification

A person with normal vision may get the following invoice information sent to him:
1. PDF's of the full invoice. These PDF's should be locked so that the user cannot change them.
2. The invoice information in XML so that he can search the XML and find the relevant information.
3. The invoice information in a form that can be input into the user's accounting system. This may require some categorisation of the sender of the invoice or the type of invoice that the sender dispatches, if the sender dispatches more than one invoice. See below.
4. Fragments of the invoice for display to the user—eg. a line in the invoice. This is of lesser importance for a sighted user, but there may be some applications where this is requested.

A customer may be permitted to classify invoices into categories so that a phone bill from a Telco will entered correctly into the accounting system. There are two ways to do this: build a table or file using a mapping process that is translated from the XML to some input format for the customer's accounting system, or allow the user to enter his own classification code so that all bills from the Telco will go into chart of accounts entry 23, for example. If the Telco sends accounts for Internet and phones, the customer may be permitted to look at the bill and classify it, or to classify the Telco account number on the invoice.

These arrangements (ie. response capability and invoice classification) utilise the repository 73 on the document server side.

1. A method for reproducing a requested source document in a requested one of available forms comprising the steps of:
(a) for each one of a plurality of documents:
(i) applying at least one access pathway to a marked-up form of the document, said access pathways defining discrete parts of the document; and
(ii) generating a fragment of said marked-up document for each said access pathway for each available form; and (b) generating a requested one or more parts of a source document in a requested form from the respective stored fragments.

2. The method of claim 1, wherein said access pathways are defined in a configuration file.

3. The method of claim 2, wherein said documents are assigned to a respective a plurality of classes, and there is a configuration file for each said class.

4. The method of clam 3, wherein said configuration file includes requestable information relating to available format that is added to said fragments.

5. The method of claim 4, comprising the further step of marking-up said source documents according to a schema, and wherein there is a separate schema for each said class.

6. The method of claim 5, further comprising creating an index list for each request maker, said index list including a set of documents available to each request maker, and lists the access pathways for each fragment of each document.

7. The method of claim 6, wherein one said fragment comprises the entire source document.

8. The method of claim 7, wherein said marked-up documents and said configuration files are in XML code.

9. The method of claim 8, wherein said requested forms include electronic, print, audio and Braille.

10. The method of claim 9, wherein said generating step includes transmitting an electronic file of said respective fragments from a server computer to a remote computer where reproduction is performed.

11. The method of claim 10, wherein, at said remote computer, a requested document is navigable by said fragments.

12. A method for reproducing a requested source document in a requested one of available forms.

13. A method for reproducing a requested source document in a requested one of available forms and formats.

14. A method for reproducing a requested source document in a requested one of available forms comprising the steps of:
(a) at a document server, for each one of a plurality of documents:
(i) applying at least one access pathway to a marked-up form of the document, said access pathways defining discrete parts of the document; and
(ii) generating a fragment of said marked-up document for each said access pathway for each available form;
(b) transmitting said fragments for said requested form for a requested document over a communication channel; and
(c) at a remote computer connected to said communication channel, generating a requested one or more parts of a source document in a requested form from the respective stored fragments.

15. The method of claim 14, further comprising defining said access pathways in a configuration file.

16. A computer system for reproducing a requested source document in a requested one of available forms comprising a processor programmed to:
(a) for each one of a plurality of documents:
(i) apply at least one access pathway to a marked-up form of the document, said access pathways defining discrete parts of the document; and
(ii) generate a fragment of said marked-up document for each said access pathway for each available form; and
(b) generate a requested one or more parts of a source document in a requested form from the respective stored fragments.

17. The computer system of claim 16, wherein said processor is programmed to perform the steps of defining said access pathways in a configuration file.

18. A computer system for reproducing a requested source document in a requested one of available forms comprising:
(a) a document server programmed to, for each one of a plurality of documents:
(i) apply at least one access pathway to a marked-up form of the document, said access pathways defining discrete parts of the document; and
(ii) generate a fragment of said marked-up document for each said access pathway for each available form;
(b) a transmission channel for transmitting said fragments for said requested form for a requested document; and
(c) a remote computer connected to said communication channel, operable to generate a requested one or more parts of a source document in a requested form from the y respective stored fragments.

19. The computer system of claim 18, further comprising customer computer means coupled to said communication channel and by which requests for documents and document forms are made to said document server.

20. A computer program product comprising a computer program on a storage medium, said computer program comprising code means for performing the steps of claim 14.

21. A computer program comprising code means for performing the steps of claim 14.

22. A method for converting a requestable source document in a requestable one of available forms to be available for reproduction comprising the steps of: for each one of a plurality of documents: (i) applying at least one access pathway to a marked-up form of the document, said access pathways defining discrete parts of the document; and (ii) generating a fragment of said marked-up document for each said access pathway for each available form.

23. The method of claim 22, wherein said access pathways are defined in a configuration file.

24. The method of claim 22, wherein said documents are assigned to a respective a plurality of classes, and there is a configuration file for each said class.

25. The method of clam 24, wherein said configuration file includes requestable information relating to available format that is added to said fragments.

26. The method of claim 25, comprising the further step of marking-up said source documents according to a schema, and wherein there is a separate schema for each said class.

27. The method of claim 26, further comprising creating an index list for each request maker, said index list including a set of documents available to each request maker, and lists the access pathways for each fragment of each document.

28. The method of claim 27, wherein one said fragment comprises the entire source document.

29. The method of claim 28, wherein said marked up documents and said configuration files are in XML code.

30. The method of claim 29, wherein said requested forms include electronic, print, audio and Braille.
